(19) United States
(12) Patent Application Publication
(10) Pub. No.: US 2016/0048353 A1
(43) Pub. Date: Feb. 18, 2016

(54) MEMORY SYSTEM AND METHOD OF CONTROLLING MEMORY SYSTEM

(71) Applicant: KABUSHIKI KAISHA TOSHIBA, Minato-ku (JP)

(72) Inventor: Masahiko NAKASHIMA, Kawasaki (JP)

(73) Assignee: KABUSHIKI KAISHA TOSHIBA, Minato-ku (JP)

(21) Appl. No.: 14/598,654

(22) Filed: Jan. 16, 2015

Related U.S. Application Data
(60) Provisional application No. 62/036,874, filed on Aug. 13, 2014.

(51) Int. Cl. G06F 3/06; H04B 5/00

(52) U.S. Cl. CPC G06F 3/0622; G06F 3/0637; G06F 3/0659; G06F 3/0688; H04B 5/0031

(57) ABSTRACT

According to one embodiment, a first controller stores access restriction information in a non-volatile first memory. A second controller reads the access restriction information from the first memory and controls access by a host device to a non-volatile second memory based on the access restriction information. The access restriction information includes a start address or a size for each of segmented areas obtained by segmenting an address space of the second memory into a plurality of areas, and first access information indicating accessibility to the segmented areas.

### CROSS-REFERENCE TO RELATED APPLICATIONS

This application is based upon and claims the benefit of priority from U.S. Provisional Application No. 62/036,874, filed on Aug. 13, 2014; the entire contents of which are incorporated herein by reference.

### FIELD

Embodiments described herein relate generally to a memory system and a method of controlling the memory system.

### BACKGROUND

A portable memory system such as a memory card provided with a function of wireless communication is known. In the case where such a memory system is mounted on a host device or in the case where such a memory system is connected to a host having the function of wireless communication via the wireless communication, information inside the memory system is accessed. There is a related art that proposes a technology whereby an unauthorized access is prevented in the above-described memory system.

### BRIEF DESCRIPTION OF THE DRAWINGS

FIG. 1 is a block diagram schematically illustrating an exemplary configuration of a memory system according to a first embodiment;

FIG. 2 is a diagram illustrating an example of access restriction information according to the first embodiment;

FIG. 3 is a diagram schematically illustrating an exemplary relation between a host device, an NAND memory controller, and an address controlled in an NAND memory;

FIGS. 4A and 4B are diagrams schematically illustrating a state of data storing position inside the NAND memory in the case where a certain segmented area is specified by a logical address;

FIG. 5 is a diagram illustrating an example of the access restriction information in the case of FIG. 3;

FIG. 6 is a flowchart illustrating an exemplary setting procedure for authentication information according to the first embodiment;

FIG. 7 is a flowchart illustrating an exemplary setting procedure for segmented areas in the memory system according to the first embodiment;

FIG. 8 is a flowchart illustrating an exemplary operational procedure at the time of starting the memory system according to the first embodiment;

FIG. 9 is a diagram schematically illustrating a state in which the memory system is mounted on the host device and initializing processing is completed;

FIG. 10 is a flowchart illustrating an exemplary procedure of data read processing from the memory system according to the first embodiment;

FIG. 11 is a flowchart illustrating an exemplary procedure of data write processing in a logical address in which data is not written according to the first embodiment;

FIG. 12 is a flowchart illustrating an exemplary procedure of data write processing to a logical address in which data is written according to the first embodiment;

FIG. 13 is a diagram illustrating an example of access restriction information according to a second embodiment;

FIG. 14 is a flowchart illustrating an exemplary procedure of initializing processing according to the second embodiment;

FIG. 15 is a diagram illustrating an exemplary area segmentation in an NAND memory according to a third embodiment; and

FIG. 16 is a diagram illustrating an example of access restriction information in the case of FIG. 15.

### DETAILED DESCRIPTION

In general, according to one embodiment, a memory system including a non-volatile first memory, a non-volatile second memory, a wireless communication unit, a first controller, and a second controller is provided. The first controller stores access restriction information received by the wireless communication unit in the first memory. The access restriction information includes a start address or a size for each of segmented areas obtained by segmenting an address space of the second memory into a plurality of areas, and first access information indicating accessibility to the segmented areas. The second controller reads the access restriction information from the first memory and controls access to the second memory by the host device mounted with the memory system based on the access restriction information.

In the following, embodiments of the memory system and a method for controlling the memory system will be described in detail with reference to the accompanying drawings. But, note that the present invention is not limited to the embodiments.

### First Embodiment

According to a first embodiment, a storage medium of a memory system is segmented into a plurality of storage areas. In the case where the memory system is connected to a host device, only a storage area selected from among the segmented storage areas is accessible for the host device and rest of non-selected areas are inaccessible for the host device.

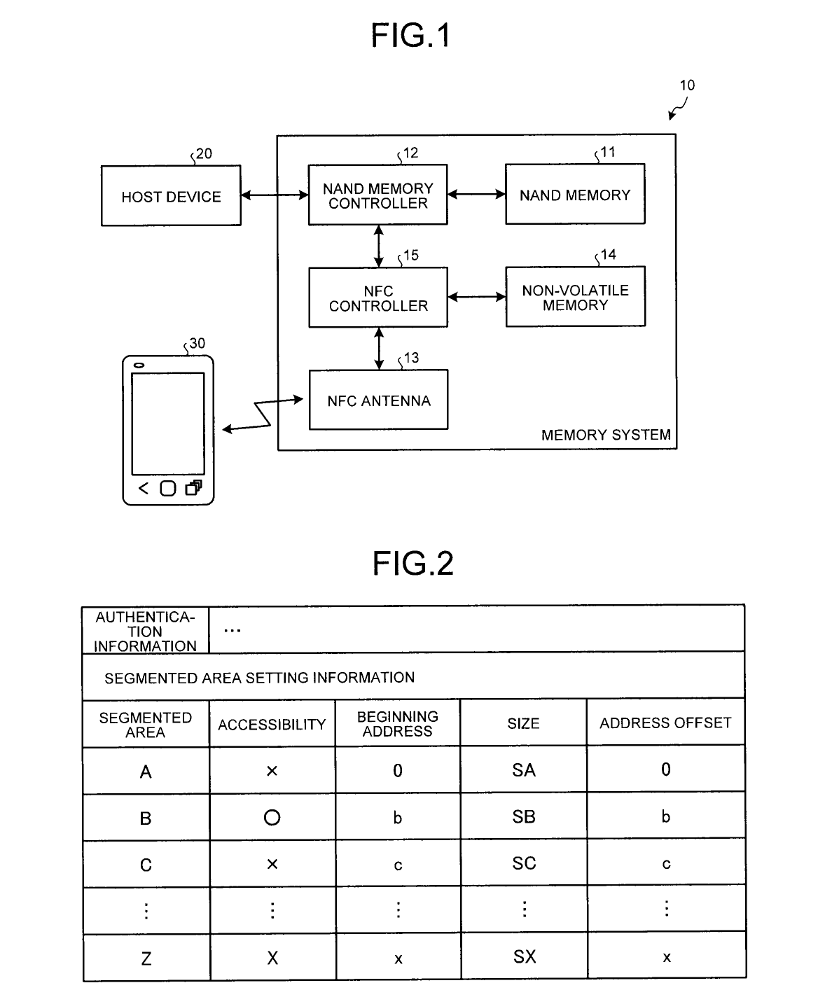

FIG. 1 is a block diagram schematically illustrating an exemplary configuration of the memory system according to the first embodiment. In this example, a memory system 10 includes an NAND flash memory (hereinafter referred to as NAND memory) 11 as a storage medium, and a memory system provided with a near field communication function according to the NFC (Near Field Communication) standards is exemplified. For the wireless communication function, other standards such as Transfer Jet may also be adopted, or the standards of a wireless LAN (Local Area Network) such as IEEE 802.11ac, IEEE 802.11n, IEEE 802.11a, IEEE 802.11g, and IEEE 802.11b may be used, too. Further, the storage medium may be the one capable of storing information in a non-volatile manner, and a magnetic disk or the like may be used in addition to the NAND memory 11. For the above-described memory system 10, a memory card, a USB (Universal Serial Bus) memory, a cassette HDD (Hard Disk Drive), etc. may be exemplified, for example.

The memory system 10 includes the NAND memory 11, an NAND memory controller 12, an NFC antenna 13, an NFC controller 15, and a non-volatile memory 14.

In the NAND memory 11, user data specified by a host device 20 is stored in the case where the memory system 10 is mounted on the host device 20. The NAND memory 11 is formed of one or a plurality of memory chips. The memory chip includes a memory cell array in which a plurality of memory cells is arrayed in a matrix. Each of the memory cells may be configured to be capable of storing one-bit data or may be configured to be capable of storing two or more bits data. Each of the memory chips is formed by arraying a plurality of physical blocks which is a unit of data erase. One physical block is formed of a plurality of physical pages. In the NAND memory 11, data writing and data reading are executed per physical page.

The NAND memory controller 12 is disposed between the host device 20 and the NAND memory 11 and executes command processing corresponding to various kinds of commands received from the host device 20 in the case where the memory system 10 is mounted on the host device 20. The command processing includes data read processing from the NAND memory 11 and data write processing in the NAND memory 11. The NAND memory controller 12 controls the NAND memory 11 by using control information such as logical-physical conversion information that shows mapping of a logical address used in the host device 20 and a physical address of the NAND memory 11 used in the memory system 10. Note that the NAND memory controller 12 controls the NAND memory 11 such that access is made only to a segmented area permitted to be accessed based on access restriction information described later.

The NAND memory controller 12 includes a host interface not illustrated and is electrically connected to the host device 20 via the host interface. For the host device 20, a personal computer, a digital still camera, a digital video camera, a smartphone, a tablet terminal, a mobile phone, etc. may be exemplified. Note that the memory system 10 is electrically connected to the host device 20 while being supported by the host device 20. In the present specification, a state in which the memory system 10 is electrically connected to the host device 20 and supported by the host device 20 is referred to as “mounted”.

The NFC antenna 13 transmits and receives information with an antenna, not illustrated, of an NFC-compatible host device 30 placed close to the memory system 10. For the NFC-compatible host device 30, a personal computer, a smartphone, a tablet terminal, a mobile phone, etc. may be exemplified. The NFC antenna 13 is connected to the NFC-compatible host device 30 by wireless communication while being placed close to the NFC-compatible host device 30.

The non-volatile memory 14 stores the access restriction information. In the case where the memory system 10 is mounted on the host device 20, the access restriction information specifies a segmented area that can be accessed by the host device 20 out of the plurality of segmented areas segmented inside the NAND memory 11.

FIG. 2 is a diagram illustrating an example of the access restriction information according to the first embodiment. The access restriction information includes authentication information and segmented area setting information. The authentication information is used to authenticate whether a user or a terminal is accessible or not at the time of accessing the access restriction information. For the authentication information, a MAC (Media Access Control) address assigned to a terminal capable of executing authentication, an RFID (Radio Frequency Identification) assigned to the NFC antenna 13 of the terminal executing authentication, a password set by a user who executes authentication, or the like may be used.

The segmented area setting information includes a segmented area, accessibility, a beginning address, a size, and an address offset. The segmented area is a name for an area obtained by segmenting the NAND memory 11 into a plurality of areas. The accessibility indicates accessibility by the host device 20 to each of the segmented areas. For example, the segmented area set accessible becomes accessible in the case of being when memory system 10 is mounted on the host device 20, and the segmented area set inaccessible becomes inaccessible in the case of being when memory system 10 is mounted on the host device 20.

The beginning address is a start address for each of the segmented areas. This address is specified by a logical address. The size is the size of each of the segmented areas. The address offset is an offset value used when an address specified from the host device 20 is converted to an address inside the segmented area set accessible. Normally, a value of the beginning address of the segmented area set accessible is to be the offset value.

The access restriction information is set by a user. Examples of segmenting method may be: a method of specifying memory capacity of each of the segmented areas, a method of specifying a memory capacity ratio in each of the segmented areas, a method of equally segmenting the NAND memory 11, or the like.

Further, the non-volatile memory 14 is formed of, for example, an EEPROM (Electrically Erasable Programmable Read-Only Memory) and an FRAM (Ferroelectric Random Access Memory) operable by power supplied from the NFC antenna 13. At least, the non-volatile memory 14 has the memory capacity smaller than that of the NAND memory 11, consuming low power, and can be accessed with high speed. The non-volatile memory 14 can be accessed by the NFC controller 15 and the NAND memory controller 12. The NFC-compatible host device 30 can recognize the data on the non-volatile memory 14 by NFC communication.

The NFC controller 15 executes the NFC communication with the NFC-compatible host device 30 via the NFC antenna 13. By executing the NFC communication, an application loaded at the NFC-compatible host device 30 can access the non-volatile memory 14 via the NFC controller 15. In other words, writing data in the non-volatile memory 14 and reading data from the non-volatile memory 14 becomes possible.

Meanwhile, the non-volatile memory 14 and NFC controller 15 are operable even when power is not supplied to the memory system 10 by power supplied from the NFC antenna 13. In other words, when the NFC-compatible host device 30 is placed close to the NFC antenna 13, or when the NFC antenna 13 is placed close to the NFC-compatible host device 30, a magnetic field is generated from the NFC-compatible host device 30 and the magnetic field generates induced electromotive force in the NFC antenna 13. Using the induced electromotive force, the non-volatile memory 14 and NFC controller 15 are operated. Therefore, data can be read from or can be written in the non-volatile memory 14 by the application of the NFC-compatible host device 30 even when the memory system 10 is not mounted on the host device 20 and power is not supplied.

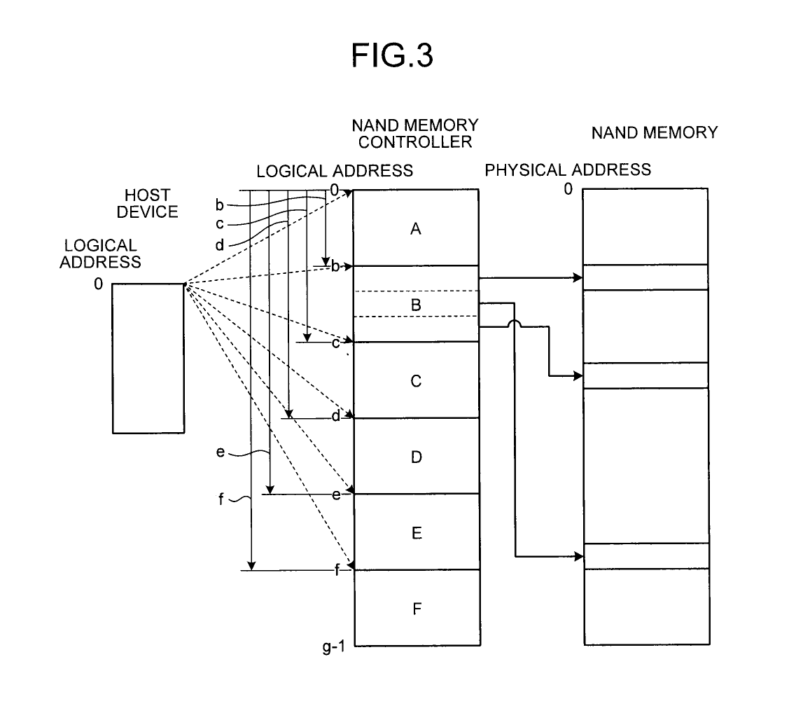

Next, operation will be described. FIG. 3 is a diagram schematically illustrating an exemplary relation between the host device, the NAND memory controller, and an address controlled in the NAND memory. Note that, a unit of data control in the host device 20 and a unit of data control in the NAND memory controller 12 is the same in the following description in order to simplify the description. The host device 20 provides an instruction by a logical address at the time of accessing the memory system 10. In the NAND memory 11, data is controlled by a physical address. In the NAND memory controller 12, data is controlled by a logical address. The NAND memory controller 12 mediates between the logical address specified at the host device 20 and the physical address used in the NAND memory 11.

Area Segmentation based on the address restriction information illustrated in FIG. 2 is executed by the logical address controlled in the NAND memory controller 12. For example, in an example of FIG. 3, following segmented areas are set: a segmented area A having the logical address 0 to b-1, a segmented area B having the logical address b to c-1, a segmented area C having the logical address c to d-1, a segmented area D having the logical address d to e-1, a segmented area E having the logical address e to f-1, and a segmented area F having the logical address f to g-1.

Note that generally there is no fixed corresponding relation between the logical address controlled in the NAND memory controller 12 and the physical address inside the NAND memory 11 in the memory system 10 including the NAND memory 11. The reason is that, in the NAND memory 11, a writing unit is a page while an erasing unit is a block. Therefore, in the case of intending to update a part of the data, a page containing the data to be updated is invalidated and writing processing for the data to be updated is performed in a different page, for example. Thus, when the data is updated, the physical address inside the NAND memory 11 where the data is stored is updated. As a result, there is no fixed corresponding relation between the logical address controlled in the NAND memory controller 12 and the physical address inside the NAND memory 11. Therefore, the relation between the logical address and the physical address is controlled based on the above-described logical-physical conversion information.

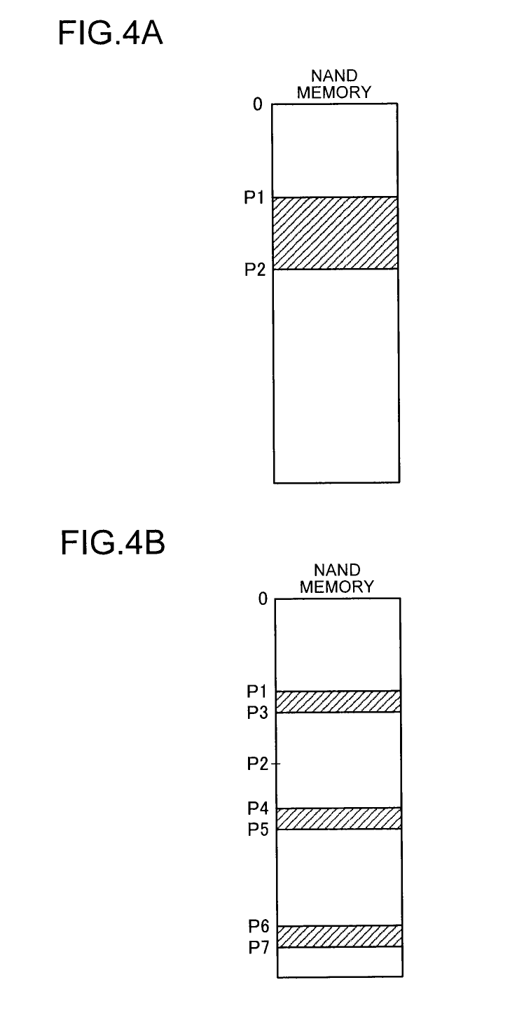

FIGS. 4A and 4B are diagrams schematically illustrating a state of data storing position inside the NAND memory in the case where a certain segmented area is specified by a logical address. For instance, in a first state, the certain segmented area is correlated to a physical address range P1 to P2 as illustrated in FIG. 4A. Then, it is assumed that data is written in or erased from the certain segmented area, and changes are made in a second state as illustrated in FIG. 4B, for example. In other words, the segmented area is correlated to segmented areas distributed to physical address ranges P1 to P3, P4 to P5, and P6 to P7. Thus, the physical address in the NAND memory 11 changes with respect to the logical address.

Thus, control is executed in the NAND memory controller 12 such that the address space is not segmented even when the address space to be controlled in the NAND memory 11 is segmented. As a result, the data of the segmented area on the logical address may be correlated to any area on the physical address.

Now, the address offset will be described. In the case where the segmented area A is set accessible and other segmented areas are set inaccessible from the host device 20, the logical address specified by the host device 20 can be used as it is in the NAND memory controller 12. In other words, the address offset is zero in this case. Further, in the case where the segmented area B is set accessible and other segmented areas are set inaccessible from the host device 20, the logical address specified by the host device 20 becomes the area inside the segmented area A set inaccessible if remaining as it is. Therefore, in the case of accessing the segmented area B, the logical address specified by the host device 20 is made to be an address added with the address offset b. By this, the address can be made to the address inside the segmented area B. The matters are same with other segmented areas C to F, and the logical address specified by the host device 20 is made to the address added with the address offset in each of the segmented area C to F.

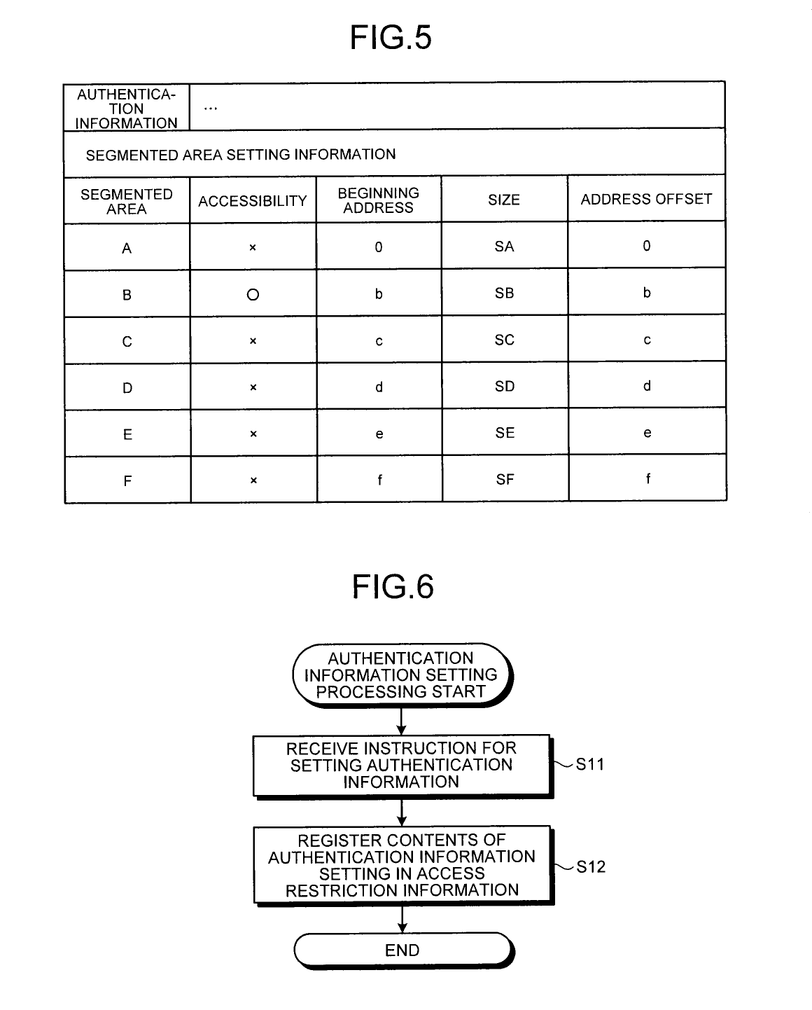

FIG. 5 is a diagram illustrating an example of the access restriction information in the case of FIG. 3. The address space having the logical address controlled by the NAND memory controller 12 is segmented into six segmented areas. The respective segmented areas are named A to F sequentially from the top. It is assumed that the beginning addresses of the respective segmented areas are zero, b, c, d, e, and f respectively. The sizes of the respective segmented areas are SA, SB, SC, SD, SE, and SF. Further, the address offsets of the respective segmented areas are zero, b, c, d, e, and f respectively. Further, only the segmented area B is permitted to be accessible and other segmented areas A, and C to F are set inaccessible.

Such setting for the access restriction information can be executed by both the NFC-compatible host device 30 and the host device 20 installed with an application for access restriction information setting. Using the application for setting the access restriction information, processing such as setting for authentication information, setting for segmented areas in the NAND memory 11, setting for accessibility in the segmented areas, and so on can be executed. In the following, setting for the authentication information and setting for the segmented areas in the NAND memory 11 will be described in the order.

(Setting for Authentication Information)

FIG. 6 is a flowchart illustrating an exemplary setting procedure for the authentication information according to the first embodiment. First, the user sets the host device 20 or the NFC-compatible host device 30 in a state accessible to the memory system 10. More specifically, the memory system 10 is mounted on the host device 20, or the NFC-compatible host device 30 is placed in the distance possible to communicable with the memory system 10 via the NFC. Then, an instruction for setting the authentication information is transmitted from the host device 20 or the NFC-compatible host device 30. The instruction for setting the authentication information includes authentication information to be set in the access restriction information. This processing can be performed by using, for example, the application for setting the access restriction information.

The NFC controller 15 of the memory system 10 receives the instruction for setting the authentication information (Step S11). Subsequently, contents of the authentication information included in the setting instruction are registered in the access restriction information of the non-volatile memory 14 (Step S12), and then the processing ends. The registered authentication information is used for authentication at the time of setting the access restriction information on and after next time.

(Setting for Segmented Areas)

Here, setting processing for segmented areas in a broad sense in which setting for the segmented areas in a narrow sense and setting for accessibility to each of the segmented areas are simultaneously executed will be described. In the setting for the segmented areas in the narrow sense, the size and the number of segmented areas are set for an original memory capacity of a memory card.

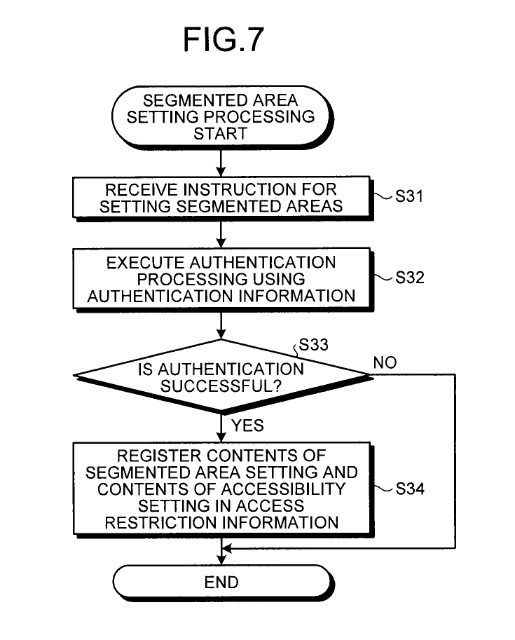

FIG. 7 is a flowchart illustrating an exemplary setting procedure of the segmented areas in the memory system according to the first embodiment. In this case also, the user sets the host device 20 or the NFC-compatible host device 30 in the state accessible to the memory system 10. Further, an instruction including setting for the segmented areas and setting for accessibility for the segmented areas are transmitted from the host device 20 or the NFC-compatible host device 30. Information related to the segmented area setting is included in the instruction for setting the segmented areas. Information related to the accessibility setting for the segmented areas is included in the instruction for setting the accessibility for the segmented areas. Further, the processing can be executed by using the application for setting the access restriction information, for example.

The NFC controller 15 of the memory system 10 receives the instruction for the segmented area setting (Step S31). Next, the NFC controller 15 executes authentication processing using the authentication information (Step S32). For instance, in the case where a password, a MAC address, or an RFID is input, the NFC controller 15 determines whether the input content matches a registered content in the access restriction information of the non-volatile memory 14. In the case of matching the registered content, authentication is successful, and in the case of not matching the same, authentication is failure.

The NFC controller 15 determines whether authentication is successful or not (Step S33). In the case where authentication is failure (No in Step S33), the processing ends without registering the setting for the segmented areas in the access restriction information. Further, in the case where authentication is successful (Yes in Step S33), the NFC controller 15 registers the contents of the instruction for setting the segmented areas and contents of the instruction for setting accessibility for the segmented areas in the access restriction information of the non-volatile memory 14 (Step S34), and the processing ends.

Note that the registered contents become effective when the memory system 10 is reset. More specifically, in the case where the memory system 10 is mounted on the host device 20, the registered contents becomes effective by hardware reset executed interlocking with ON/OFF of the power supply to the memory system 10. Also, initialization same as the hardware reset may be implemented by software reset executed by a command of memory access. This prevents memory access to the memory system 10 from being interrupted halfway.

Note that the case in which setting for the segmented areas in the narrow sense and setting for accessibility for the segmented areas are simultaneously executed has been described above. However, setting for the segmented areas in the narrow sense and setting for accessibility for the segmented areas may be executed separately.

Next, a description is given for a case in which the memory system 10 already set with an accessible area is mounted on the host device 20. Here, initializing processing for the memory system 10 and access processing to the segmented area permitted to be accessed will be described.

(Initializing Processing)

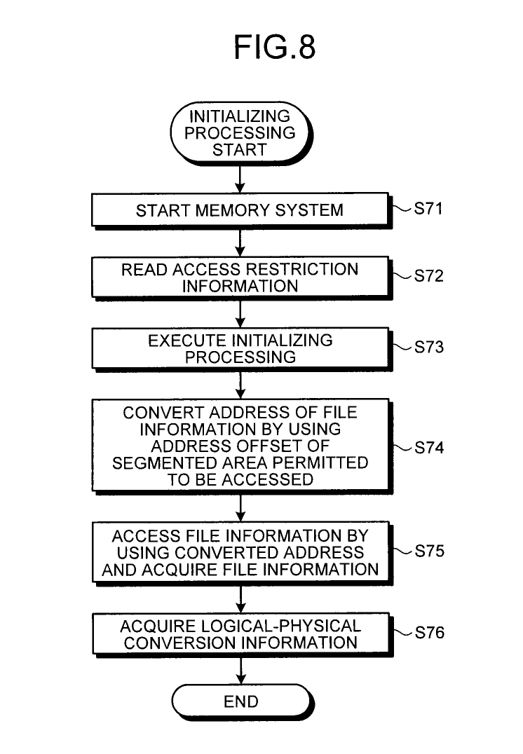

FIG. 8 is a flowchart illustrating an exemplary operational procedure at the time of starting the memory system according to the first embodiment. First, the user mounts the memory system 10 on the host device 20. By this, power is supplied to the memory system 10 and the memory system 10 is started (Step S71). Next, the NAND memory controller 12 reads the access restriction information of the non-volatile memory 14 (Step S72).

Further, the NAND memory controller 12 executes the initializing processing that includes, for example, setting for control values in various kinds of registers for operation control (Step S73). At the time of the initializing processing, the NAND memory controller 12 generally writes a value indicating an entire memory capacity of the memory system 10 in a CSIZE of a CSR register (Control and Status Register). However, according to the first embodiment, the NAND memory controller 12 acquires a size of a segmented area set accessible from the access restriction information, and sets the size in the CSIZE. By this, the memory capacity of the memory system 10 viewable from the host device 20 can be matched to the memory capacity of the segmented area accessible by the host device 20.

Subsequently, the NAND memory controller 12 converts an address for accessing file information by using the address offset of the segmented area permitted to be accessed in the access restriction information (Step S74). For instance, in the case of FAT (File Allocation Table) table, the file information containing the FAT table is stored at the head of a space indicated by a logical address controlled by the host device 20. Therefore, in the case where the logical address is as it is, the file information is read in the segmented area unpermitted to be accessed. To avoid this, the NAND memory controller 12 converts the logical address received from the host device 20 by using the address offset of the segmented area permitted to be accessed. In other words, the address offset is added to the requested address.

After that, the NAND memory controller 12 accesses the file information of the segmented area permitted to be accessed by using the converted address, and acquires the file information (Step S75). Further, the NAND memory controller 12 accesses the logical-physical conversion information stored at a predetermined position of the NAND memory 11, and acquires the logical-physical conversion information (Step S76). With the above procedure, the initializing processing ends, and access to the memory system 10 from the host device 20 becomes accessible.

Note that the file information is information that controls a position of a file and a directory stored inside the segmented area. At this time, the stored file and directory is described by using a virtual address that is a logical address allocated to the stored position when a beginning address of the segmented area is set as an address number zero.

Further, in the case of executing software reset, the command for software reset is executed instead of start of the memory system 10 in Step S71.

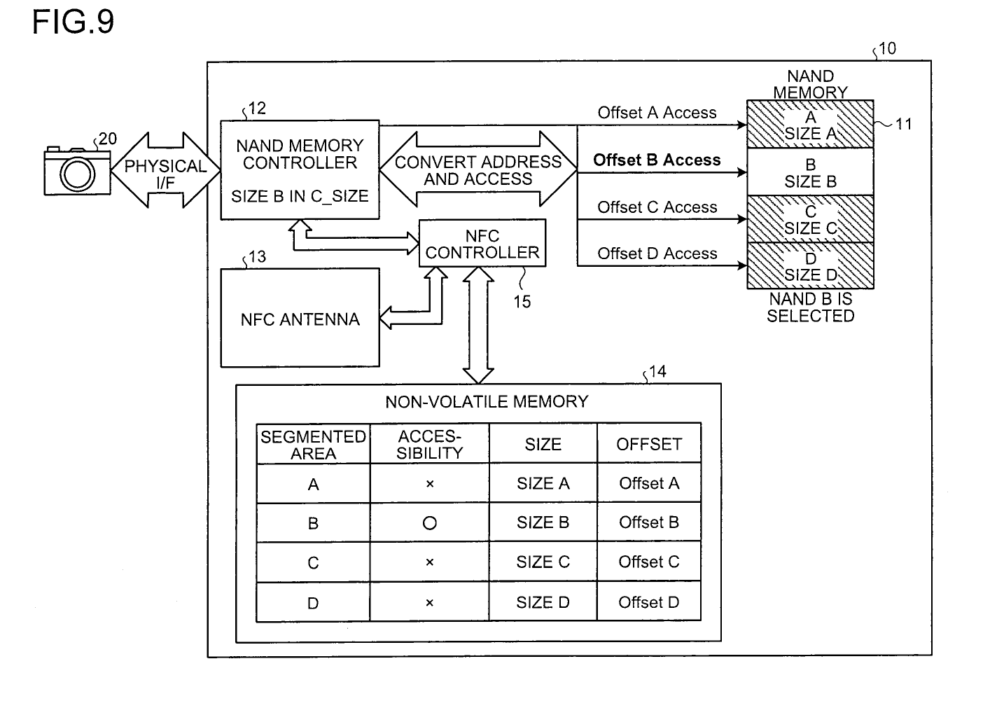

FIG. 9 is a diagram schematically illustrating a state in which the memory system is mounted on the host device and the initializing processing is completed. When the memory system 10 is mounted on the host device 20 such as a digital still camera, the initializing processing in FIG. 8 is executed. According to the access restriction information of the non-volatile memory 14, the segmented area B is set accessible. Therefore, the NAND memory controller 12 executes processing such that only the segmented area B can be viewed from the host device 20 out of the four segmented areas A to D inside the NAND memory 11. In FIG. 9, the segmented areas A, C, and D set inaccessible are indicated by hatched areas.

Further, the NAND memory controller 12 sets, in the CSIZE, a value indicating the size SIZE B of the segmented area B acquired from the access restriction information. By this, the size of the mounted memory system 10 is recognized as the SIZE B in the host device 20. Note that, in FIG. 9, the NAND memory 11 is illustrated so as to be segmented into the segmented areas A to D. However, in this example, the NAND memory is segmented into the plurality of segmented areas A to D on the logical addresses in the NAND memory controller 12 as described above.

(Data Read Processing)

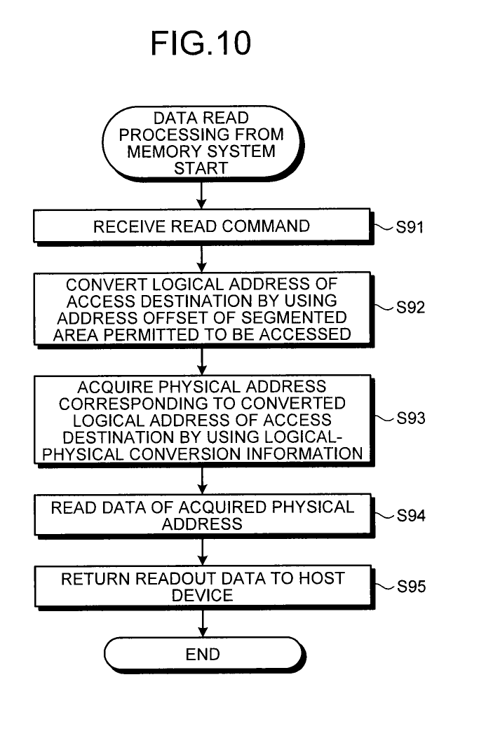

FIG. 10 is a flowchart illustrating an exemplary procedure of data read processing from the memory system according to the first embodiment. First, the NAND memory controller 12 of the memory system 10 receives a data read command from the host device 20 (Step S91). Next, the NAND memory controller 12 converts a logical address of an access destination included in the read command to a logical address in the NAND memory controller 12 (Step S92). At this time, an address offset of a segmented area currently set accessible is used. More specifically, the address offset is added to the logical address of the access destination included in the read command to convert the logical address to the logical address specifying the inside of the segmented area. Exemplifying the case in FIG. 9, the offset B of the accessible segmented area B is added to the logical address from the host device 20, and the logical address is converted to the address that enables access to the segmented area B.

Subsequently, the NAND memory controller 12 acquires a physical address corresponding to the converted logical address by using the logical-physical conversion information (Step S93). After that, the NAND memory controller 12 reads the data stored in a position indicated by the acquired physical address (Step S94). Then, the NAND memory controller 12 returns the readout data to the host device 20 (Step S95), and the processing ends.

(Data Write Processing)

Here, first a description is given for write processing in the logical address in which no data is written, and next the description will be given for the write processing in the logical address in which data is written.

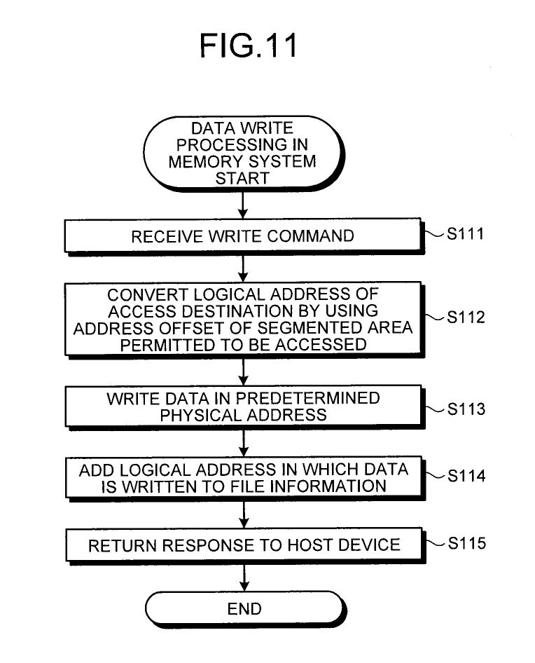

FIG. 11 is a flowchart illustrating an exemplary procedure of data write processing in a logical address in which data is not written according to the first embodiment. First, the NAND memory controller 12 of the memory system 10 receives a data write command from the host device 20 (Step S111). Next, the NAND memory controller 12 converts a logical address of an access destination included in the write command to a logical address controlled in the NAND memory controller 12 (Step S112). At this time, an address offset of a segmented area currently set accessible is used.

After that, the NAND memory controller 12 writes the data commanded by the write command in a position of the physical address correlated to the logical address of the access destination (Step S113). At this time, write processing is performed at the physical address in which no data is stored.

Further, the NAND memory controller 12 adds the information related to the data written in Step S113 to the file information together with the logical address (Step S114). Meanwhile, information including a name of the written data and a virtual address inside the segmented area storing the data (logical address specified by the host device 20 in this case) are written in the file information at this time. Then, a response indicating completion of the data write processing is returned to the host device 20 (Step S115). After this, the processing ends.

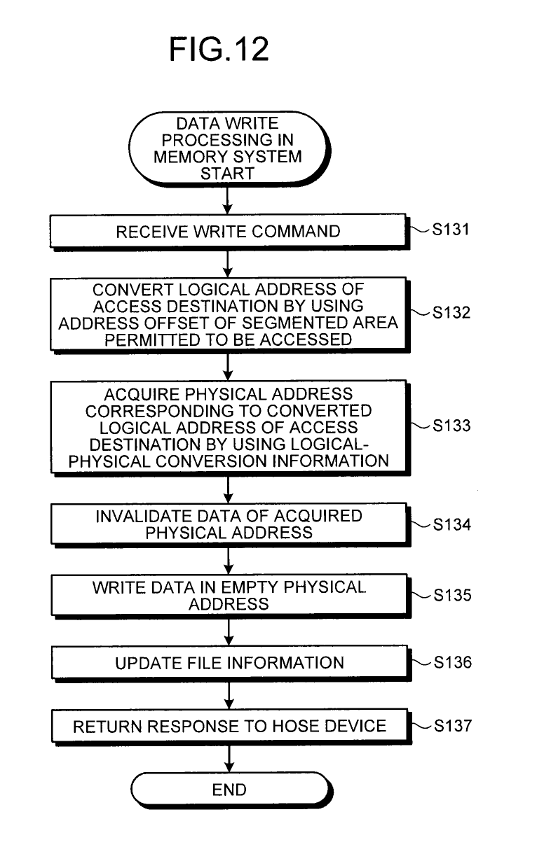

FIG. 12 is a flowchart illustrating an exemplary procedure of data write processing in a logical address in which data is written according to the first embodiment. First, the same processing as Steps S111 to S112 in FIG. 11 is executed. In other words, when a write command is received, a logical address of an access destination is converted to a logical address in the NAND memory controller 12 by using an address offset (Steps S131 to S132).

Subsequently, the NAND memory controller 12 acquires a physical address corresponding to the converted logical address of the access destination by using the logical-physical conversion information (Step S133). After that, the NAND memory controller 12 invalidates the data of the physical address acquired in Step S133 (Step S134). Then, the data is written in the physical address in which no data is currently stored (Step S135).

After that, the NAND memory controller 12 updates the file information (Step S136). Here, information related to the data added in Step S135 is added. Then, a response indicating completion of the data write processing is returned to the host device 20 (Step S137). After this, the processing ends.

Meanwhile, in FIGS. 10 to 12, in the case where an access destination address from the host device 20 is out of the range of the segmented area set accessible, the NAND memory controller 12 does not accept the command. For instance, the NAND memory controller 12 returns an error. By this, access to external areas other than the area set accessible is prevented.

Further, in the case where a control state of the memory access to the memory system 10 is in an accessed state, setting change in the access restriction information may be stopped. This can prevent command sequence of the memory system 10 from causing failure.

According to the first embodiment, the NAND memory 11 is segmented into a plurality of segmented areas, the address restriction information including the beginning address, size, address offset, and accessibility for each of the segmented areas is stored in the non-volatile memory 14. When the memory system 10 is reset, only the segmented area set accessible based on the access restriction information is set so as to be accessible from the host device 20. Further, the size of the segmented area permitted to be accessed is indicated instead of the actual size of the NAND memory 11 at the host device 20. By this, access to the segmented areas other than the segmented area permitted to be accessed from the host device 20 can be prevented. As a result, it is possible that only a specific area can be viewed by the host device 20.

Registering and updating of the access restriction information inside the non-volatile memory 14 is executed from the NFC-compatible host device 30 via the NFC antenna 13. This enables power to be supplied to the non-volatile memory 14 and NFC controller 15 by placing the NFC-compatible host device 30 close to the memory system 10 even when the memory system 10 is not mounted on the host device 20 and no power is supplied. As a result, the access restriction information can be registered or updated.

The access restriction information is stored in the authentication information. By this, the authentication processing using the authentication information can be executed in the case of updating the access restriction information. As a result, it is possible that the access restriction information is prevented from being updated from a user or the NFC-compatible host device 30 not authenticated.

When the memory system 10 is reset after the access restriction information is updated, access to the segmented area is restricted based on the updated access restriction information. According to this, memory access to the memory system 10 is prevented from being interrupted halfway even in the case accessibility setting for the segmented area preliminarily set is changed via the NFC while memory access is being executed to the memory system 10.

### Second Embodiment

According to a first embodiment, when accessibility is set for a segmented area, a host device mounted with a memory system accesses the same segmented area until setting for accessibility is changed. According to a second embodiment, a case in which setting for accessibility can be validated only once will be described.

A configuration of a memory system 10 according to the second embodiment is substantially same as the one described in the first embodiment, but is partly different in access restriction information inside a non-volatile memory 14 and a function of an NFC controller 15.

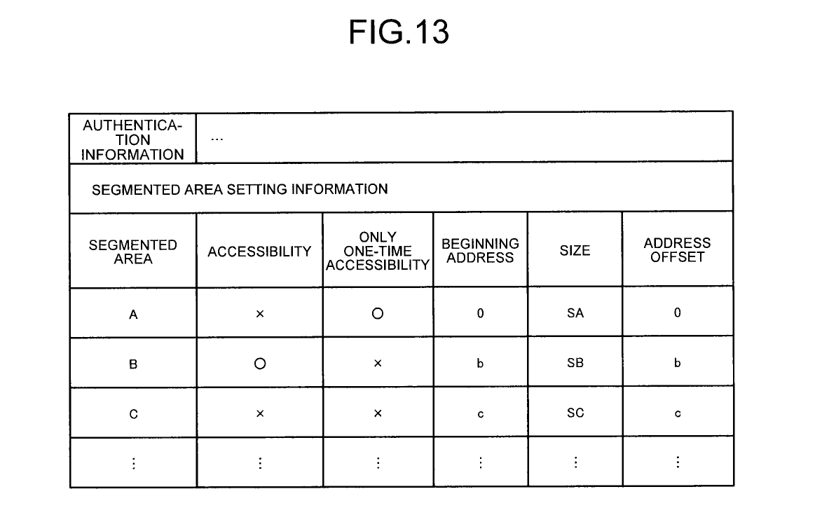

FIG. 13 is a diagram illustrating an example of access restriction information according to the second embodiment. The access restriction information includes an additional item of only one-time accessibility to items in FIG. 2 according to the first embodiment. The only one-time accessibility is applied to set a content to be executed when the memory system 10 is reset next time in preference to a content that has been set in the accessibility. In other words, the only one-time accessibility is to specify a segmented area to be validated only once when the memory system 10 is mounted on a host device 20 after setting. Note that in the case where nothing is input in the item of the only one-time accessibility, setting access for the segmented areas is set in accordance with the item of accessibility as described in the first embodiment.

For instance, in FIG. 13, a segmented area B is set accessible, but a segmented area A is set accessible only one time. Therefore, when the memory system 10 is reset next time, the segmented area A can be accessed, but when the memory system 10 is reset again, the segmented area B can be accessed.

The memory system 10 is reset after updating the item of the only one-time accessibility in the access restriction information, and then an NFC controller 15 resets the item of the only one-time accessibility in the access restriction information. In other words, this is a state in which nothing is set in the item of the only one-time accessibility for all of the segmented areas.

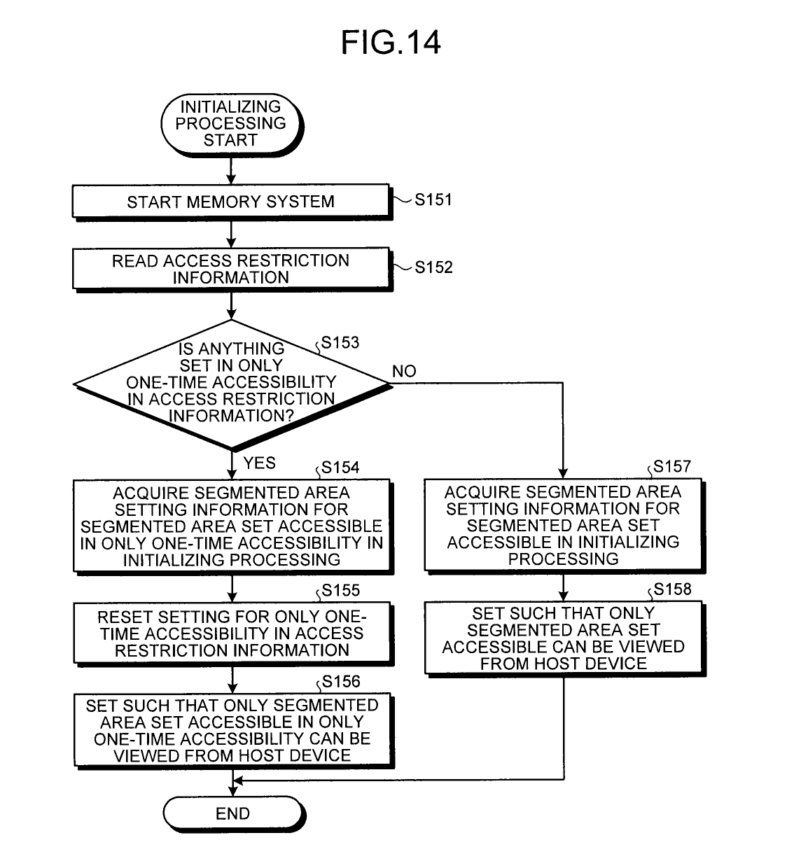

FIG. 14 is a flowchart illustrating an exemplary procedure of initializing processing according to the second embodiment. First, resetting the memory system 10 is commanded from the host device 20, and the memory system 10 is started (Step S151). Next, an NAND memory controller 12 reads the access restriction information inside the non-volatile memory 14 (Step S152).

The NAND memory controller 12 determines whether anything is set in the item of the only one-time accessibility in the access restriction information (Step S153). In the case where something is set in the item of the only one-time accessibility (Yes in Step S153), the NAND memory controller 12 acquires segmented area setting information for a segmented area set accessible only one time in the initializing processing (Step S154).

Subsequently, the NAND memory controller 12 resets the item of the only one-time accessibility in the access restriction information (Step S155). In other words, setting for the segmented area for which the only one-time accessibility is validated is invalidated. After that, setting is made such that only the segmented area for which the one-time accessibility is set can be viewed from the host device 20 (Step S156), and the processing ends.

On the other hand, in the case where nothing is set in the item of the only one-time accessibility in Step S153 (No in Step S153), the segmented area setting information is acquired for the segmented area set accessible in the item of accessibility of the access restriction information in the initializing processing (Step S157). After that, setting is made such that only the segmented area set accessible can be viewed from the host device (Step S158), and the processing ends.

According to the second embodiment, the item of the only one-time accessibility is provided in the access restriction information. This brings an effect that data can be prevented from being viewed by other users in the case where, for example, a user surely knows that the memory system 10 is reset and used again afterward but a next user to access the memory system 10 may not be the user.

### Third Embodiment

According to a first embodiment, one segmented area is selected, and only the selected segmented area can be viewed from a host device mounted with a memory system. However, the number of the segmented area that can be viewed from the host device is not limited to one.

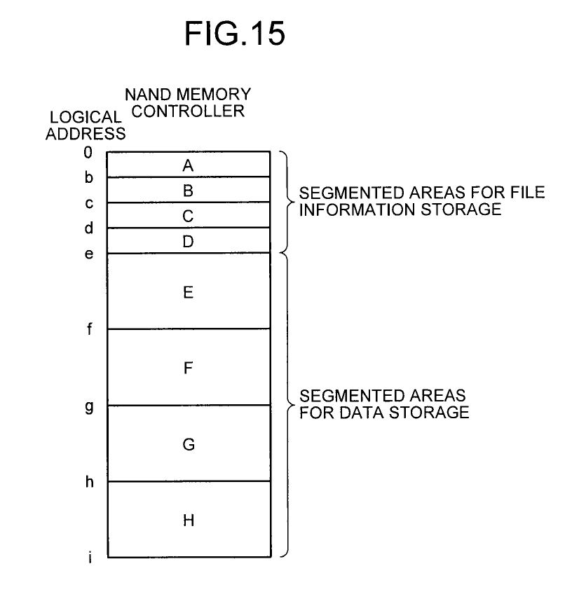

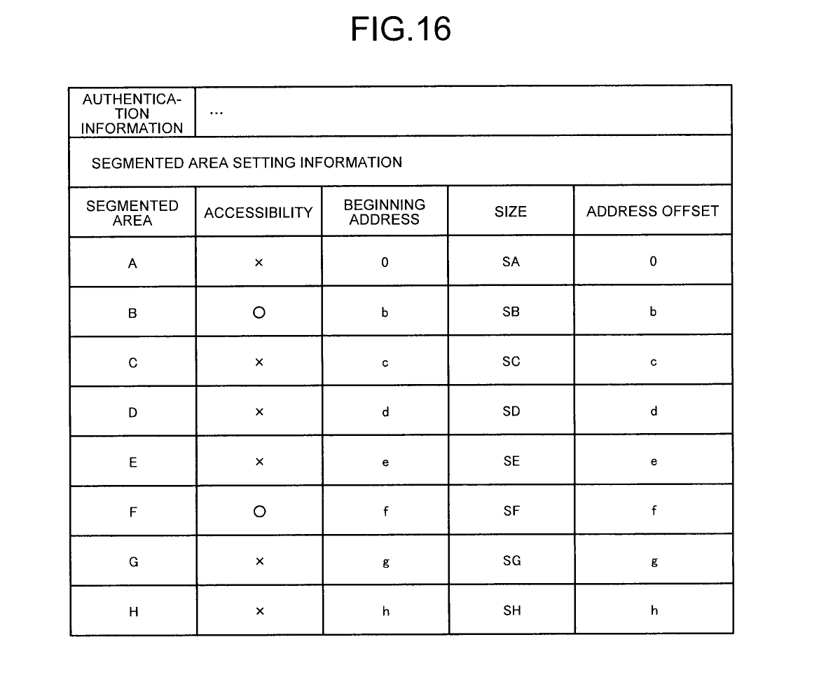

FIG. 15 is a diagram illustrating an example of area segmentation in an NAND memory according to a third embodiment, and FIG. 16 is an example of access restriction information in the case of FIG. 15. As illustrated in FIG. 15, an address space of an NAND memory controller 12 is segmented into a plurality of segmented areas for file information storage and a plurality of segmented areas for data storage. The segmented areas for file information storage store file information stored in correlated segmented areas for data storage. The segmented areas for data storage store data written by a user. Therefore, preferably, the segmented areas for file information storage has a size smaller, compared to the segmented areas for data storage. Further, the segmented areas for file information storage at least needs the size that can store the file information related to the data stored in the segmented areas for data storage. In the example of FIG. 15, segmented areas A to D are the segmented areas for file information storage, and segmented areas E to H are the segmented area for data storage.

Further, as illustrated in FIG. 16, accessibility in the access restriction information can be set for a plurality. At this time, accessible areas are selected respectively from the segmented areas for file information storage and the segmented areas for data storage. Note that a description for other parts of the access restriction information will be omitted as is same as the first embodiment.

According to the access restriction information like the third embodiment, an access method to an NAND memory 11 in the NAND memory controller 12 is different. In other words, a different address offset is used between access to the file information and access to the data. For instance, exemplifying the case in FIG. 16, the segmented areas set accessible are the segmented areas B and F. More specifically, the file information of the segmented area F is stored in the segmented area B. Therefore, in the case of accessing the file information, an address offset b of the segmented area B which is the segmented area for file information storage is added to a logical address from a host device 20. Also, in the case of accessing the data, an address offset f of the segmented area F which is the segmented area for data storage is added to the logical address from the host device 20. Note that a description for rest of processing will be omitted as is same as the first embodiment.

According to the third embodiment also, the same effects as the first embodiment can be obtained.

Note that, the above describes a case in which a unit of data control in the host device 20 and a unit of data control in the NAND memory controller 12 is the same in order to simplify the description. However, the unit of data control in the host device 20 may be set different from the unit of the data control in the NAND memory controller 12. For example, in the host device 20, logical addresses assigning sectors with sequential serial numbers from zero may be used setting a sector (having the size of 512B, for example) as the unit. Also, in the NAND memory controller 12, logical addresses assigning clusters with sequential serial numbers from zero may be used setting a cluster having the size of a plurality of sectors as the unit. In this case, the NAND memory 11 is controlled by physical addresses assigning the clusters with the sequential serial numbers from zero. In this case, the NAND memory controller 12 needs to perform processing to convert the logical address included in a command from the host device 20 to a logical address in the NAND memory controller 12.

Further, it has been described above that the segmented areas are set in a logical address space controlled by the NAND memory controller 12, but the segmented areas may be set in a physical address space in the NAND memory 11.

Additionally, according to the above description, a beginning address and a size of the segmented area is included in the access restriction information. However, actually at least one of the beginning address and size of the segmented area is to be included in the access restriction information. The reason is that a position of the segmented area can be specified when any one of the beginning address and the size is included. An example in which a segmented area is specified by the size will be described. When the segmented areas are arranged in an ascending order of the start addresses in the logical address space controlled by the NAND memory controller 12, which number of the segmented area is identifiable. Accordingly, the start address of the specified segmented area can be acquired by summing memory capacity of the segmented areas immediately before the segmented area specified in the access restriction information. Therefore, in the case where at least either the beginning address or the size of the segmented area is included in the access restriction information as described above, the position of the segmented area can be specified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile first memory;
a non-volatile second memory;
a wireless communication unit;
a first controller configured to store access restriction information received by the wireless communication unit in the first memory, the access restriction information including a start address or a size for each of segmented areas obtained by segmenting an address space of the second memory into a plurality of areas and first access information indicating accessibility to the segmented areas; and
a second controller configured to read the access restriction information from the first memory and control access to the second memory by the host device mounted on the memory system based on the access restriction information.

2. The memory system according to claim 1, wherein the start address is specified by using a logical address space in which the second controller controls the second memory.

3. The memory system according to claim 1, wherein the second controller reads the access restriction information at the time of initialization of the memory system executed after the access restriction information is stored in the first memory.

4. The memory system according to claim 1, wherein the second controller notifies, as the size of the memory system, the host device of the size of the segmented area set accessible based on the access restriction information at the time of initializing processing.

5. The memory system according to claim 1, wherein
the access restriction information further includes an address offset for each of the segmented areas, and
the second controller converts an address of an access destination commanded from the host device by using the address offset, the address offset corresponding to the segmented area set accessible in the readout access restriction information.

6. The memory system according to claim 1, wherein
the access restriction information further includes, for each of the segmented areas, a first address offset representing a beginning address of an area storing file information of the segmented area, and a second address offset representing a beginning address of an area storing data of the segmented area, and
in the case of acquiring file information of the segmented area set accessible in the address restriction information, the second controller converts a first address of access destination to the file information by using the first address offset, and in the case of accessing data of the segmented area set accessible in the address restriction information, the second controller converts a second address of access destination to the data by using the second address offset.

7. The memory system according to claim 1, wherein
the access restriction information further includes second access information indicating only one-time accessibility to the segmented area, and
in the case where the second access information is set, the second controller controls access by the host device to the second memory based on the second access information at the time of initializing the memory system.

8. The memory system according to claim 7, wherein the second controller resets the second access information of the access restriction information in the first memory after the initialization.

9. The memory system according to claim 1, wherein the access restriction information further includes authentication information that restricts access to the first memory.

10. The memory system according to claim 9, wherein the authentication information is a password, or a MAC address or an RFID assigned to an information processing terminal capable of wirelessly communicating with the wireless communication unit.

11. The memory system according to claim 1, wherein the wireless communication unit includes an antenna, supplies an induced electromotive force generated in the antenna at the time of wireless communication to the first controller and the first memory, and stores the access restriction information in the first memory.

12. The memory system according to claim 11, wherein
the wireless communication unit executes wireless communication by means of a Near Field Communication function according to NFC standards,
the first memory is an EEPROM or an FRAM, and
the second memory is an NAND flash memory or a magnetic disk.

13. A method of controlling a memory system including a non-volatile first memory, a non-volatile second memory, and a wireless communication unit, comprising:
reading an access restriction information from the first memory, the access restriction information including a start address or a size for each of segmented areas obtained by segmenting the second memory into a plurality of areas, and first access information indicating accessibility to the segmented areas, and
controlling access to the second memory by a host device mounted with the memory system based on the access restriction information.

14. The method of controlling a memory system according to claim 13, further comprising, storing the access restriction information received by the wireless communication unit in the first memory;

15. The method of controlling a memory system according to claim 13, wherein the start address is specified by using a logical address space in which the second memory is managed.

16. The method of controlling a memory system according to claim 13, wherein the reading the access restriction information is executed at the time of initializing the memory system after storing the access restriction information in the first memory.

17. The method of controlling a memory system according to claim 13, further comprising, notifying the size of the segmented area set accessible in the access restriction information to the host device as a size of the memory system after the reading the access restriction information before the controlling access to the second memory.

18. The method of controlling a memory system according to claim 13, wherein
the access restriction information further includes an address offset for each of the segmented areas, and
in the controlling of access to the second memory, an address of an access destination commanded from the host device is converted by using the address offset, the address offset corresponding to the segmented area set accessible in the read access restriction information.

19. The method of controlling a memory system according to claim 13, wherein
the access restriction information further includes, for each of the segmented areas, a first address offset representing a beginning address of an area storing file information of the segmented area, and a second address offset representing a beginning address of an area storing data of the segmented area, and
in the controlling of access to the second memory, in the case of acquiring file information of the segmented area set accessible in the address restriction information, a first address of access destination to the file information is converted by using the first address offset, and in the case of accessing data of the segmented area set accessible in the address restriction information, a second address of access destination to the data is converted by using the second address offset.

20. The method of controlling a memory system according to claim 13, wherein
the access restriction information further includes second access information indicating only one-time accessibility to the segmented area, and
in the controlling of access to the second memory, in the case where the second access information is set, control is executed based on the second access information at the time of initializing the memory system.
